(19) United States
(12) Patent Application Publication
(10) Pub. No.: US 2026/0140708 A1
(43) Pub. Date: May 21, 2026

(54) METHOD, APPARATUS, DEVICE AND STORAGE MEDIUM FOR CODE EDITING

(71) Applicant: DOUYIN VISION CO., LTD., Shijingshan District, Beijing (CN)

(72) Inventors: Yuhuan Huang, Beijing (CN); Yinghao Wang, Beijing (CN)

(21) Appl. No.: 19/123,141

(22) PCT Filed: Apr. 25, 2024
(86) PCT No.: PCT/CN2024/089924

§ 371 Date: Apr. 22, 2025

(51) Int. Cl. G06F 8/33

(52) U.S. Cl. CPC G06F 8/33

(57) ABSTRACT

The embodiments of the disclosure relate to a method, a device, an equipment and a storage medium for code editing. The method provided herein includes: obtaining an editing suggestion for a target code in a code editing interface, wherein the code editing interface is provided by an editing application; determining a set of decorators for presenting the editing suggestion at least based on a type of the editing suggestion; and displaying the set of decorators associated with the target code in the code editing interface to present at least part of the editing suggestion. In this way, the embodiments of the disclosure can effectively improve the efficiency of code editing.

### FIELD

Example embodiments of the present disclosure generally relate to the field of computers, and in particular, to methods, apparatuses, devices, and computer readable storage media for code editing.

### BACKGROUND

With the development of the Internet, a user for example may edit code through a code editing interface of an electronic device. How to improve efficiency in a user code editing process is a key focus.

### SUMMARY

In a first aspect of the present disclosure, a method for code editing is provided. The method comprises: obtaining an editing suggestion for a target code in a code editing interface provided by an editing application; determining a set of decorators for presenting the editing suggestion at least based on a type of the editing suggestion; and displaying a set of decorators associated with the target code in the code editing interface to present at least part of the editing suggestion.

In a second aspect of the present disclosure, an apparatus for code editing is provided. The apparatus comprises: an obtaining module configured to obtain an editing suggestion for a target code in a code editing interface provided by an editing application; a first determining module configured to determine a set of decorators for presenting the editing suggestion at least based on a type of the editing suggestion; and a display module configured to display a set of decorators associated with the target code in the code editing interface to present at least part of the editing suggestion.

In a third aspect of the present disclosure, an electronic device is provided. The apparatus comprises at least one processing unit; and at least one memory coupled to the at least one processing unit and storing instructions for execution by the at least one processing unit. The instructions, when executed by the at least one processing unit, causing the device to perform the method of the first aspect.

In a fourth aspect of the present disclosure, a computer readable storage medium is provided. The computer readable storage medium stores a computer program, and the computer program is executable by the processor to implement the method of the first aspect.

In a fifth aspect of the present disclosure, a computer program product is provided. The computer program product comprises computer executable instructions that, when executed by a processor, implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The abovementioned and other features, advantages, and aspects of various embodiments of the present disclosure will become more apparent from the following detailed description with reference to the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2 illustrates an example interface according to some embodiments of the present disclosure;

FIG. 3 shows a flowchart of an example process of code editing according to some embodiments of the present disclosure;

FIG. 4 shows a schematic structural block diagram of an apparatus for code editing according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms, and should not be interpreted as limited to the embodiments described in this specification. On the contrary, these embodiments are provided for a more thorough and complete understanding of the present disclosure. It should be understood that the accompanying drawings and embodiments of the present disclosure are only for the purposes of illustration and are not intended to limit the scope of the present disclosure.

It should be noted that the title of any section/subsection provided in this specification is not limiting. Various embodiments are described throughout the specification and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and similar terms would be appreciated as open-ended inclusion, that is, “including but not limited to”. The term “based on” would be appreciated as “at least partially based on”. The terms “one embodiment” or “the embodiment” would be appreciated as “at least one embodiment”. The term “some embodiments” would be appreciated as “at least some embodiments”. Other explicit and implicit definitions may also be included below. The terms “first,” “second,” and the like may refer to different or identical objects. The following may further include other explicit and implicit definitions.

Embodiments of the present disclosure may relate to user data, acquisition and/or use of data, and the like. These aspects shall comply with the requirements of corresponding laws, regulations and relevant provisions. In the embodiments of the present disclosure, the collection, acquisition, processing, manufacturing, forwarding, use of all data and the like are carried out with the knowledge and consent of the users. Accordingly, in the implementation of the embodiments of the present disclosure, users should be informed of the type, the scope of use, the use scenario, etc., of the possibly involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract, etc.) and will be performed only within a specified or agreed scope. If users decline the processing of personal information beyond what is essential for basic functionalities, their utilization of these basic features remains uninterrupted.

The embodiment of the disclosure provides a solution for code editing. According to the solution, an editing suggestion for a target code in a code editing interface may be obtained, and the code editing interface is provided by an editing application. Further, determine a set of decorators for presenting the editing suggestion at least based on a type of the editing suggestion. Further, display the set of decorators associated with the target code in the code editing interface to present at least part of the editing suggestion.

In this way, the embodiments of the present disclosure can present the editing suggestion for the target code based on the editing interface provided by the editing application, and highlight for at least part of different types of the editing suggestions by different decorators, thereby may effectively improve the efficiency of code editing.

Various example implementations of this solution are described in detail below with reference to the accompanying drawings.

### Example Environment

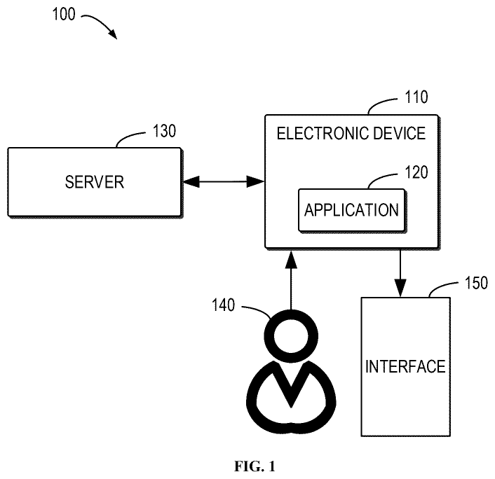

FIG. 1 illustrates a schematic diagram of an example environment 100 in which embodiments of the present disclosure can be implemented. In this example environment 100, an application 120 is installed in the electronic device 110. The user 140 may interact with the application 120 via the electronic device 110 and/or its attachment device. The application 120 may be a code editing application, or may be any other plug-in with an ability to edit code items.

In environment 100 of FIG. 1, if the application 120 is in active status, the electronic device 110 may present the interface 150 of the application 120. The interface 150 may include various interfaces that the application 120 may provide, such as an code editing interface.

In some embodiments, the electronic device 110 communicates with the server 130 to provide services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of user interface (such as a “wearable” circuit, etc.). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described only for the purpose of illustration, without suggesting any limitation to the scope of the present disclosure.

Some example embodiments of the present disclosure will be described below with continued reference to the accompanying drawings.

### Example Interaction

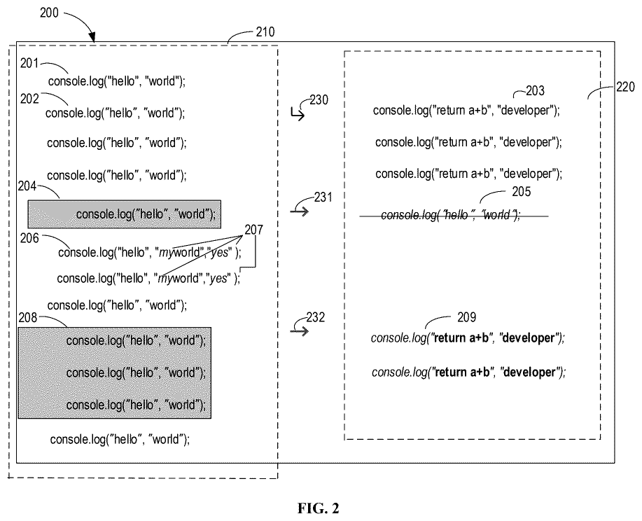

An example code editing process according to some embodiments of the present disclosure will be described below with reference to FIG. 2. FIG. 2 illustrates an example code editing interface 200, which may be provided by the electronic device 110 shown in FIG. 1, according to some embodiments of the present disclosure.

In some embodiments, the electronic device 110 may, for example, support a user to edit code in the code editing interface. Taking FIG. 2 as an example, the code editing interface 200 may include the in-code editing 210 by the user.

When the user edits the target code based on the code editing interface 200, the electronic device may obtain an editing suggestion for the target code in the code editing interface 200, and present at least part of the editing suggestion in the code editing interface 200. The edit suggestion indicates how to edit the target code. The editing suggestion may include, but is not limited to, information such as a code modification range and code editing content. The code editing interface is provided by an editing application.

Taking FIG. 2 as an example, the code editing interface 200 may include target code 202, target code 204, target code 206, and the like, code editing content 203 for the target code 202, code editing content 205 for the target code 204, and code editing content 209 for the target code 206. In some embodiments, the editing suggestions correspond to different types, and the type may include but may be not limited to at least one of the following: an insertion type, a deletion type, and a modification type. The modification types may further include an inline completion type and a non-inline completion type. The insertion type is used to represent a target position in which the code editing content is inserted into the target code, wherein the target position may be any appropriate position in the target code, for example, if the target code includes two lines of code, the target position may be an intermediate position of the two lines of code. The deletion type is used to represent the deletion of the target code. The modification type is used to represent the modification of the target code to other code. Specifically, the inline completion type in the modification type is used to represent the completion of an incomplete word or a sentence in a line where the target code is located, and at this time, the number of lines on the target code corresponds to the number of lines in the code editing content. The number of lines corresponding to the target code corresponding to the non-inline completion type in the modification type is generally not exactly the same as the number of lines of corresponding to the code in the code editing content.

In some embodiments, the electronic device may obtain the in-code editing by the user in the code editing interface. The electronic device may send the currently in-editing code to the target device, so that the target device may obtain the editing suggestion based on the currently in-code editing and the target model deployed in the target device.

In some embodiments, the editing suggestion may be a suggestion information in a form of “modify the code of the line range [x, y) to the code s ”. The line range [x, y) represents the code in the range from line x to the line before line y in the in-code editing, the line range [x, y) may also be referred to as the code modification range, and the code in the range from xₜₕ line to the line before the yₜₕ line may be referred to as the target code. S is code editing content. If x equals to y, and s is not empty, then the electronic device may determine that the type of editing suggestion is “insertion type”. If s is empty and x is not equal to y, the electronic device may determine that the type of editing suggestion is “deletion type”. If x equals to y and s is empty, the electronic device may ignore the current edit. If x is not equal to y and s is not empty, the electronic device may determine that the type of the editing suggestion is “modification type”. Further, the electronic device may determine whether the type of the editing suggestion is the “inline completion type” or the “non-inline completion type”, based on whether the number of lines corresponding to the target code in the line range [x, y) and the code editing context s are identical, and whether the difference between the target code and the code editing context at the character level only include adding characters without deleting characters. If the number of lines corresponding to the target code in the line range [x, y) and the code editing content s are identical, and the difference between the target code and the code editing content at the character level only includes adding characters without deleting characters, the electronic device may determine that the type of the editing suggestion is the “inline completion type”. If the number of lines corresponding to the target code in the line range [x, y) and the code editing content s are not identical, or if the difference between the target code and the code editing content at the character level includes character deletion, the electronic device may determine that the type of the editing suggestion is “non-inline completion type”. In some embodiments, when displaying the code editing content of the non-inline completion type, the electronic device displays the code editing content based on the difference at the word level.

In some embodiments, the electronic device may use the diffCharts function from the jsdiff package during the implementation to compare the target code and the code editing content to determine differences in character levels (char levels) for each line. The electronic device may also use the diffWorld WeithSpace function from the jsdiff package during the implementation to compare the target code and code editing content to determine differences in word levels for each line.

In some embodiments, for ease of distinction, different types of editing suggestions may be configured to correspond to different decorators in the editing interface. Each editing suggestion may correspond to a set of decorators. The decorator is configured to render the editing suggestion, so that the editing suggestion is displayed in the code editing interface in a corresponding display form.

In some embodiments, the electronic device may determine a first decorator corresponding to the type of the editing suggestion, and the first decorator is configured to display a symbol element corresponding to the type. The symbol element is used to display a type corresponding to the editing suggestion in the code editing interface, and the symbol elements for different types may be the same or different and can be configured as needed. In some embodiments, the electronic device may further determine, in response to the type of the editing suggestion satisfying the second predetermined condition, the code editing content corresponding to the editing suggestion. The electronic device may determine a set of third decorators corresponding to the code editing content, the set of third decorators is configured to display the code editing content. In some embodiments, the number of the set of third decorators is determined based on a number of lines of the code editing content, wherein a line of code corresponds to a third decorator. The second predetermined condition may be any appropriate condition. As an example, the second predetermined condition may be that the type of the code suggestion is not the inline completion type.

In some embodiments, the display position of the first decorator may be determined based on a code modification range for the editing suggestion. The display position of the set of third decorators may also be determined by the electronic device based on the code range for the editing suggestion.

As an example, the display positions of the first decorator and the set of third decorators may further be determined based on the code range and the number of lines corresponding to the code editing content.

Taking FIG. 2 as an example, the first line of the code 203 may be displayed aligned with the line where the code 202 is located, and in the editing interface 200 of the electronic device, the character 230 may be displayed between the last character of the code 202 and the first character of the first line of the code 203, to represent that the type corresponding to the editing suggestion is the insertion type, and the code 230 is inserted between the code 201 and the code 202.

As shown in FIG. 2, as an example, the first line of the code 205 may be displayed aligned with the first line of the code 204, and the editing interface 200 of the electronic device may also display the character 231 between the first character of the first line of the code 205 and the last character of the first line of the code 204, to represent that the type corresponding to the editing suggestion is the deletion type, and specially to represent to delete the code 204. As another example, the electronic device may determine a first target code having a smallest number of lines in the code 204 and the code 205, and align the intermediate line of the first target code with the character 231. It should be noted that, if the first target code consists an even line code, there may be no intermediate line, and in this case, the electronic device may align the line preceding the intermediate position of the first target code with the character 231. Taking FIG. 2 as an example, both the code 204 and the code 205 include a line of code, the first target code may be the code 204 or the code 205, and the character 231 is located in the same line as the code 204 and the code 205 in the editing interface 200.

As shown in FIG. 2, as an example, the first line of the code 209 may be displayed aligned with the first line of the code 208, and in the editing interface 200 of the electronic device, the character 232 may also be displayed between the first character of the first line of the code 209 and the last character of the first line of the code 208, to represent that the type of the editing suggestion is the non-inline completion type in the modification type, that is, the code 208 is modified to the code 209. As another example, the electronic device may determine a second target code with the smallest number of lines of code between the code 208 and the code 209, and align the intermediate line code in the second target code with the character 232. It should be noted that, if the second target code consists an even number of lines, there may be no intermediate line, and in this case, the electronic device may align the line preceding the intermediate position in the second target code with the character 232. Taking FIG. 2 as an example and the code 209 as the second target code, but the number of lines corresponding to the second target code is 2, the first line code in the code 209 may be aligned with the character 232.

In some embodiments, the electronic device may further determine, in response to the type satisfying the first predetermined condition, a code portion of the target code modified by the editing suggestion; and determine a second decorator corresponding to the code portion, the second decorator being configured to differentially display the modified code portions in the target code. As an example, the second decorator may set the target code to a predetermined background color. As another example, the second decorator may also set the modified code part in the target code to be italicized or bold.

Taking FIG. 2 as an example, the electronic device may also set a predetermined background color to the code 208. The electronic device may also set a predetermined background color to the code 204. The electronic device may also display the corresponding modified portion in the code 206 in an inclined style.

In some embodiments, the electronic device determines a display position of the set of third decorators based on the code modification range. In response to the set of third decorators exceeding the first boundary of the code editing area of the code editing interface, adjust the display position of the group of third decorators. The first boundary may be the last line of code that the code editing interface allows to display.

As shown in FIG. 2, if the last line of code of code 208 is the last line of code the editing interface, allows to display and code 209 includes more than three lines of code, then the fourth line and the subsequent lines of code of the code 209 cannot be displayed in the editing interface.

To address the issue of incomplete code display, as an example, the electronic device may move the code 209 upwards, so that the last line code of the code 209 is aligned with the last line code allowed to be displayed by the editing interface to adjust the display position of the group of third decorators.

The electronic device may, in response to the adjusted set of third decorators exceeding the second boundary of the code editing area, control at least one of the set of third decorators not to be displayed such that only part of the code editing content is presented, the second boundary may be the first line of code that the code editing interface allows to display.

For example, if after the first line of the code 209 is moved up to the position which aligns with the first line of code that the editing interface allows to displayed, the code 209 still has an incomplete display issue, then the electronic device may display the part of the code 209 in the editing interface. For ease of reminding, the electronic device may also allow the line where the last line of code displayed in the editing interface is located to display prompt information on the last line of the editing interface that is allowed to display code, indicating that a portion of the code 209 may not be fully displayed in the editing interface 200. and the prompt information is used to indicate that the code 209 is not displayed in the editing page 200.

In some embodiments, a set of decorators includes at least a first set of decorators corresponding to the first line of code and a second set of decorators corresponding to the second line of code, wherein the first set of decorators and the second set of decorators have the same indentation in the code editing interface. The first set of decorators and the second set of decorators may decorate different lines of code, respectively. The first code and the second code may be represented as code of different lines.

Taking FIG. 2 as an example, the first line in code 203 has the same indentation as the second line in code 203.

In some embodiments, there may be a certain distance relationship between the character element and the target code and the display position of the code editing content in the code editing interface.

Taking FIG. 2 as an example, the character 231 and the last character of the code 204 may be separated by a predetermined number of characters, and the character 231 and the first character of the code 205 may be separated by a predetermined number of characters.

Taking FIG. 2 as an example, the character 232 and the intermediate line code of the second target code may be separated by a predetermined number of characters, the character 232 and the last character of the code line corresponding to the intermediate line code of the second target code line in the third target code line may also be separated by a predetermined number of characters, and the third target code line may refer to another code line in the code 209, excluding the second target code line.

It should be noted that, the code editing content for the inline completion editing suggestion and the non-inline editing suggestion may be displayed in different display manners.

For non-inline completion type of editing suggestions, not all content may be modified in the target code and the code editing content, and for ease of display, in some embodiments, the electronic device may display consistent content (content that does not need to be modified) in the target code and the code editing content and inconsistent content (content that needs to be modified) in the target code and the code editing content in different display manners, that is, display consistent content and inconsistent content in different styles. As an example, the electronic device may set the content that does not require modification to be displayed in italics, set the content that needs to be modified to be displayed in bold, and the like. Taking FIG. 2 as an example, for the first line of code in the code 208, “Console.log(“” unmodified content, may be displayed in italics in the editing interface, while “return a+b” is modified, then it is displayed in bold in the editing interface.

For editing suggestions for inline completion, the electronic device may display the code editing content at a target location in the target code in a no difference style. Taking FIG. 2 as an example, in response to the type of the editing suggestion being the inline completion type, the electronic device may directly insert the code 207 into the code 206, and set the code 207 to the italic to represent that the type of the editing suggestion is a line completion type, and specifically indicating that the code 207 is used to complete the line where the code 206 is located.

The following describes a process of rendering each line of code in an editing interface based on decorators, character elements representing a type of various editing suggestions, and a display style set of each code. In some embodiments, adjacent and comprising the same style of characters (the code is composed of multiple characters) is rendered by one type of decoration after pseudo element, that is, one decoration type may be applied to one text range, and one decoration type is implemented by one text decorator.

Taking FIG. 2 as an example, the character 230, the two characters between the character 230 and the last character of the code 202, and a predetermined number of characters between the character 230 and a first character of the code 203 are implemented by a text decorator, the first line code of the code 203 is implemented by a text decorator, a second line code of the code 203 is implemented by a text decorator, and a third line code of the code 203 is implemented by a text decorator.

The background color set by the character 204 corresponds to one text decorator, the character 231, the predetermined number of characters between the character 231 and the last character of the code 204, the predetermined number of characters between the character 231 and the first character of the code 205 are implemented by a text decorator, and the code 205 corresponding to the deleted style is implemented by a text decorator.

The preceding sub-code in the code 207 is implemented by a text decorator, and the subsequent sub-code corresponds to one text decorator, that is, the code 207 corresponds to two text decorators.

“Console.log (”” in code 209 is implemented by a text decorator, “return a+b” is implemented by a text decorator, “”,“” is implemented by a text decorator, and “developer” is implemented by a text decorator,“”);” is implemented by a text decorator.

It should be noted that the display style of each piece of code, the display style of the symbols indicating the edit types in FIG. 2 is merely an example, and do not limit the scope of the present disclosure.

The present disclosure may display, in an editing interface the suggested edits comprising a plurality of lines of code, based on a plurality of text decorators or may represent an edit type corresponding to the suggested edits with characters and different display styles can be applied to each piece of code or character.

In this way, the embodiments of the present disclosure can display the editing suggestion for the target code based on the editing interface provided by the editing application, and highlight the different decorators for at least part of different types of editing suggestions, thereby effectively improving the efficiency of code editing.

### Example Processes

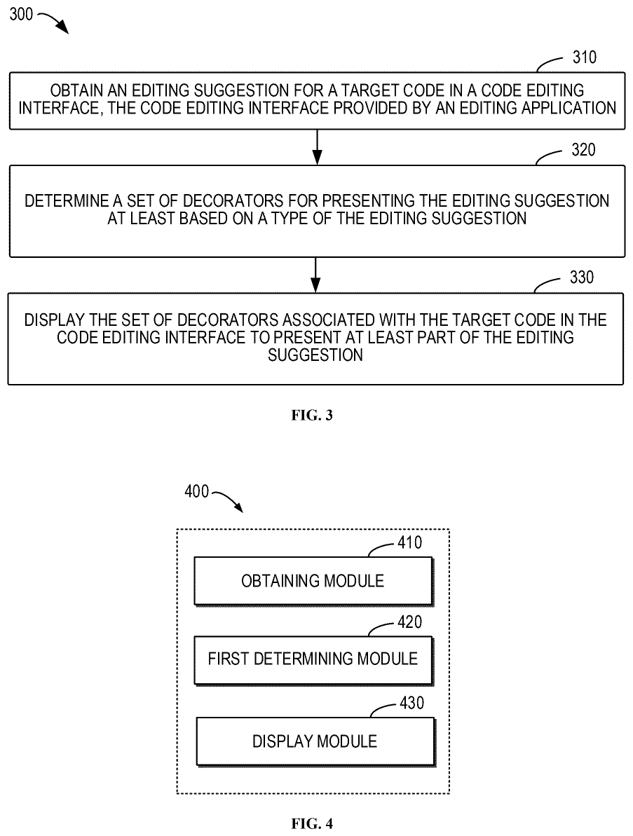

FIG. 3 illustrates a flowchart of an example process 300 for code editing in accordance with some embodiments of the present disclosure. Process 300 may be implemented at electronic device 110. The process 300 is described below with reference to FIG. 1.

As shown in FIG. 3, at block 310, the electronic device 110 obtains an editing suggestion for the target code in the code editing interface provided by the editing application.

At block 320, the electronic device 110 determines a set of decorators for presenting the editing suggestion at least based on the type of editing suggestion.

At block 330, the electronic device 110 displays, in the code editing interface, a set of decorators associated with the target code to present at least part of the editing suggestion.

In some embodiments, the process 300 further includes: determining the type of the editing suggestion based on a code modification range and the code editing content for the editing suggestion, wherein the type includes an insertion type, a deletion type, or a modification type.

In some embodiments, determining the set of decorators for presenting the editing suggestion at least based on the type of the editing suggestion includes determining a first decorator corresponding to the type of the editing suggestion, the first decorator being configured to display a symbol element corresponding to the type.

In some embodiments, the display position of the first decorator is determined based on a code modification range for the editing suggestion.

In some embodiments, determining the set of decorators for presenting the editing suggestion at least based on the type of the editing suggestion includes: in response to the type satisfying the first predetermined condition, determining a code portion of the target code modified by the editing suggestion; and determining a second decorator corresponding to the code portion, the second decorator being configured to differentially display the modified code portion in the target code.

In some embodiments, determining the set of decorators for presenting the editing suggestion at least based on the type of the editing suggestion includes: in response to the type satisfying the second predetermined condition, determining code editing content corresponding to the editing suggestion; and determining a set of third decorators corresponding to the code editing content, the set of third decorators being configured to display the code editing content, and a number of the set of third decorators being determined based on a number of lines of the code editing content.

In some embodiments, the process 300 further includes determining a display position of the set of third decorators based on the code modification range for the editing suggestion.

In some embodiments, determining the display position of the set of third decorators based on the code modification range for the editing suggestion includes: determining a display position of the set of third decorators based on the code modification range; and adjusting the display position of the set of third decorators in response to the set of third decorators exceeding the first boundary of the code editing region of the code editing interface.

In some embodiments, the process 300 further includes, in response to the adjusted set of third decorators exceeding the second boundary of the code editing area, controlling at least one of the set of third decorators not to be displayed such that only part of the code editing content is presented.

In some embodiments, the display style of the code editing content in the set of third devices is determined based on an editing type of the code editing content.

In some embodiments, the set of decorators includes at least a first set of decorators corresponding to the first line of code and a second set of decorators corresponding to the second line of code, wherein the first set of decorators and the second set of decorators having the same indentation in the code editing interface.

In some embodiments, the indentation is determined based on a length of a predetermined code line of the target code displayed in the code editing interface.

### Example Apparatus and Apparatus

Embodiments of the present disclosure also provide a corresponding apparatus for implementing the abovementioned method or process.

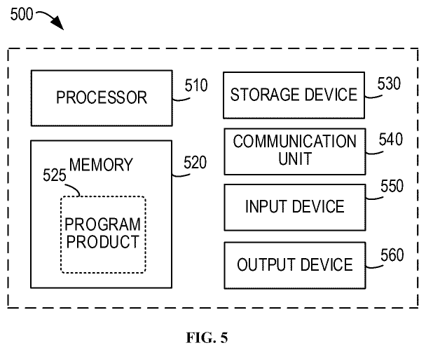

FIG. 4 shows a schematic structural block diagram of an apparatus 400 for code editing according to some embodiments of the present disclosure. The apparatus 400 may be implemented or may be included in the electronic device 110. The various modules/components in the apparatus 400 may be implemented by hardware, software, firmware, or any combination thereof.

The apparatus 400 includes an obtaining module 410 configured to obtain an editing suggestion for a target code in a code editing interface provided by an editing application; a first determining module 420 configured to determine a set of decorators for presenting the editing suggestion at least based on a type of the editing suggestion; and a display module 430 configured to display the set of decorators associated with the target code in the code editing interface to present at least part of the editing suggestion.

In some embodiments, the apparatus 400 further includes a second determining module configured to determine a type of the editing suggestion based on the code modification range and the code editing content for the editing suggestion, wherein the type includes an insertion type, a deletion type, or a modification type.

In some embodiments, the first determining module 420 is specifically configured to determine a first decorator corresponding to the type of the editing suggestion, and the first decorator being configured to display a symbol element corresponding to the type.

In some embodiments, the display position of the first decorator is determined based on a code modification range for the editing suggestion.

In some embodiments, the first determining module 420 is specifically configured to determine, in response to the type satisfying the first predetermined condition, a code portion of the target code modified by the editing suggestion; and determine a second decorator corresponding to the code portion, the second decorator being configured to differentially display the modified code portion in the target code.

In some embodiments, the first determining module 420 is specifically configured to determine, in response to the type satisfying the second predetermined condition, code editing content corresponding to the editing suggestion; and determine a set of third decorators corresponding to the code editing content, the set of third decorators being configured to display code editing content, and a number of the group of third decorators being determined based on the number of lines of the code editing content.

In some embodiments, the apparatus 400 further includes a third determining module configured to determine a display position of the set of third decorators based on the code modification range for the editing suggestion.

In some embodiments, the third determining module is specifically configured to determine the display position of the set of third decorators based on the code modification range; and adjust the display position of the set of third decorators in response to the set of third decorators exceeding the first boundary of the code editing area of the code editing interface.

In some embodiments, the apparatus 400 further includes a control module configured to, in response to the adjusted set of third decorators exceeding the second boundary of the code editing area, control at least one of the set of third decorators not to be displayed such that only part of c the code editing content is presented.

In some embodiments, the display style of the code editing content in the set of third devices is determined based on the editing type of the code editing content.

In some embodiments, the set of decorators includes at least a first set of decorators corresponding to the first line of code and a second set of decorators corresponding to the second line of code, wherein the first set of decorators and the second set of decorators have the same indentation in the code editing interface.

In some embodiments, the indentation is determined based on a length of a predetermined code line of the target code displayed in the code editing interface.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data (e.g., training data for training) and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer readable program instructions may also be stored in a computer readable storage medium that cause the computer, programmable data processing apparatus, and/or other devices to function in a particular manner, such that the computer readable medium storing instructions includes an article of manufacture including instructions to implement aspects of the functions/acts specified in the flowchart and/or block diagram(s).

The computer readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for code editing, comprising:
obtaining an editing suggestion for a target code in a code editing interface, the code editing interface provided by an editing application;
determining a set of decorators for presenting the editing suggestion at least based on a type of the editing suggestion; and
displaying the set of decorators associated with the target code in the code editing interface to present at least part of the editing suggestion.

2. The method of claim 1, further comprising:
determining the type of the editing suggestion based on a code modification range and code editing content for the editing suggestion, wherein the type comprises: an insertion type, a deletion type, or a modification type.

3. The method of claim 1, wherein determining the set of decorators for presenting the editing suggestion at least based on the type of the editing suggestion comprising:
determining a first decorator corresponding to the type of the editing suggestion, the first decorator being configured to display a symbol element corresponding to the type.

4. The method of claim 3, wherein a display position of the first decorator is determined based on a code modification range for the editing suggestion.

5. The method of claim 1, wherein determining the set of decorators for presenting the editing suggestion at least based on the type of the editing suggestion comprising:
in response to the type satisfying a first predetermined condition, determining a code portion of the target code modified by the editing suggestion; and
determining a second decorator corresponding to the code portion, the second decorator configured to differentially display the modified code portion in the target code.

6. The method of claim 1, wherein determining the set of decorators for presenting the editing suggestion at least based on the type of the editing suggestion comprising:
in response to the type satisfying a second predetermined condition, determining code editing content corresponding to the editing suggestion; and
determining a set of third decorators corresponding to the code editing content, the set of third decorators being configured to display the code editing content, a number of the set of third decorators determined based on a number of lines of the code editing content.

7. The method of claim 6, further comprising:
determining a display position of the set of third decorators based on a code modification range for the editing suggestion.

8. The method of claim 7, wherein determining the display position of the set of third decorators based on the code modification range for the editing suggestion comprising:
determining the display position of the set of third decorators based on the code modification range; and
adjusting the display position of the set of third decorators, in response to the set of third decorators exceeding a first boundary of a code editing area of the code editing interface.

9. The method of claim 8, further comprising:
in response to the adjusted set of third decorators exceeding a second boundary of the code editing area, controlling at least one of the set of third decorators not to be displayed such that only part of the code editing content is presented.

10. The method of claim 6, wherein a display style of the code editing content in the set of third decorators is determined based on an editing type of the code editing content.

11. The method of claim 1, wherein the set of decorators comprises at least a first set of decorators corresponding to a first line of code and a second set of decorators corresponding to a second line of code, wherein the first set of decorators and the second set of decorators having the same indentation in the code editing interface.

12. The method of claim 11, wherein the indentation is determined based on a length of a predetermined code line of the target code displayed in the code editing interface.

13. (canceled)

14. An electronic device, comprising:
at least one processor; and
at least one memory coupled to the at least one processor and storing instructions for execution by the at least one processor, the instructions, when executed by the at least one processor, causing the electronic device to perform operations comprising:
obtaining an editing suggestion for a target code in a code editing interface, the code editing interface provided by an editing application;
determining a set of decorators for presenting the editing suggestion at least based on a type of the editing suggestion; and
displaying the set of decorators associated with the target code in the code editing interface to present at least part of the editing suggestion.

15. (canceled)

16. The electronic device of claim 14, wherein the operations further comprise:
determining the type of the editing suggestion based on a code modification range and code editing content for the editing suggestion, wherein the type comprises: an insertion type, a deletion type, or a modification type.

17. The electronic device of claim 14, wherein determining the set of decorators for presenting the editing suggestion at least based on the type of the editing suggestion comprising:
determining a first decorator corresponding to the type of the editing suggestion, the first decorator being configured to display a symbol element corresponding to the type.

18. The electronic device of claim 17, wherein a display position of the first decorator is determined based on a code modification range for the editing suggestion.

19. The electronic device of claim 14, wherein determining the set of decorators for presenting the editing suggestion at least based on the type of the editing suggestion comprising:
in response to the type satisfying a first predetermined condition, determining a code portion of the target code modified by the editing suggestion; and
determining a second decorator corresponding to the code portion, the second decorator configured to differentially display the modified code portion in the target code.

20. The electronic device of claim 14, wherein determining the set of decorators for presenting the editing suggestion at least based on the type of the editing suggestion comprising:
in response to the type satisfying a second predetermined condition, determining code editing content corresponding to the editing suggestion; and
determining a set of third decorators corresponding to the code editing content, the set of third decorators being configured to display the code editing content, a number of the set of third decorators determined based on a number of lines of the code editing content.

21. The electronic device of claim 20, wherein the operations further comprise:
determining a display position of the set of third decorators based on a code modification range for the editing suggestion.

22. A non-transitory computer program product comprising computer executable instructions, wherein the computer executable instructions, when executed by a processor, implement operations comprising:
obtaining an editing suggestion for a target code in a code editing interface, the code editing interface provided by an editing application;
determining a set of decorators for presenting the editing suggestion at least based on a type of the editing suggestion; and
displaying the set of decorators associated with the target code in the code editing interface to present at least part of the editing suggestion.
